(19) United States
(12) Patent Application Publication
(10) Pub. No.: US 2014/0002646 A1
(43) Pub. Date: Jan. 2, 2014

(54) BOTTOM OF THE BASKET SURVEILLANCE SYSTEM FOR SHOPPING CARTS

(71) Applicant: Ron Scheffer, Las Vegas, NV (US)

(72) Inventor: Ron Scheffer, Las Vegas, NV (US)

(21) Appl. No.: 13/927,921

(22) Filed: Jun. 26, 2013

Related U.S. Application Data
(60) Provisional application No. 61/664,899, filed on Jun. 27, 2012.

(51) Int. Cl. H04N 7/18

(52) U.S. Cl. CPC H04N 7/18
USPC 348/143

(57) ABSTRACT

A bottom of the basket shopping cart detection system includes one or more lights, cameras, a controller configured to process images from the one or more cameras to detect items at the bottom of the basket, and one or more visual or audible alarms.

### RELATED APPLICATION DATA

The present application claims priority to U.S. Provisional Patent Application Ser. No. 61/664,899, filed Jun. 24, 2012.

### FIELD OF THE INVENTION

The present invention relates to methods and devices for detecting the presence of items in a shopping cart at check-out and, more specifically, items located in a bottom portion of the cart.

### BACKGROUND OF THE INVENTION

Shopping carts which are used to transport goods through a store to the check-out area commonly have a top “basket” portion and a lower shelf. The lower shelf is commonly referred to as the “bottom of the basket” or “BOB.”

Shoppers may place items for purchase into the basket and onto the lower shelf. Problems often arise in ensuring that all of the items associated with the cart are accounted for at check-out. For example, in some cases a shopper will unload the items from the basket portion of the cart but forget to unload the item from the lower shelf. In other instances, shoppers may intentionally leave items on the lower shelf in the hope that they will not be noticed and then not be charged for them.

The problems associated with the carts are exacerbated because most checkers work behind a check-out counter which blocks most of the cart, including the bottom shelf, from direct view. Thus, the checker is unlikely to be able to see or otherwise notice that the shopper has items associated with their cart which has not been accounted for.

A variety of systems and devices have been proposed for addressing this problem. Such proposed solutions include the use of mirrors, scales and similar devices. However, all of these proposed solutions have a number of associated problems such as difficulty in use, unreliability and the like.

### SUMMARY OF THE INVENTION

Aspects of the invention comprise methods and system for detecting the presence of items at the bottom of shopping cart.

In one embodiment, a bottom of the basket shopping cart detection system includes one or more lights, cameras, a controller configured to process images from the one or more cameras to detect items at the bottom of the basket, and one or more visual or audible alarms.

Further objects, features, and advantages of the present invention over the prior art will become apparent from the detailed description of the drawings which follows, when considered with the attached figures.

### DESCRIPTION OF THE DRAWINGS

FIG. 1 schematically illustrates a system of the invention;

FIG. 2 schematically illustrates an implementation of the invention; and

FIG. 3 illustrates a secondary display associated with an existing check-out station.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a simple surveillance detection system capable of isolating or detecting products in the BOB area of a cart, such as to address and/or document intentional and/or unintentional loss of products. In general, the surveillance detection system isolates a specific proximity area and documents that specific area for goods to be noticed and accountable with visuals. The system has the ability to supply a record of documentation to supply a retailer with a history of actions per employee and enhance the participation with the checker to be conscious of losses and their surroundings.

System

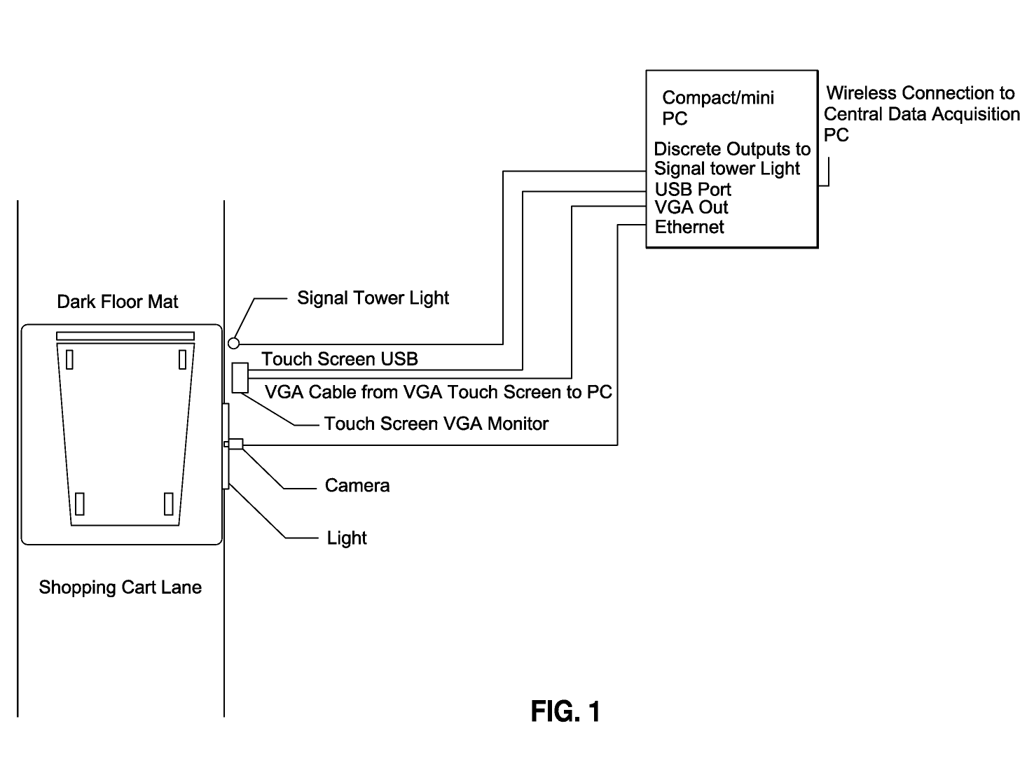

One embodiment of a system of the invention will be described with reference to FIGS. 1-3. As illustrated in FIG. 1, at least one digital monochrome and/or color camera is mounted approximately, but not limited to, 16 inches above the surface of a floor or other location which may support a shopping cart (this distance is a variable based on the size of the target items which need to be detected in the BOB area, and thus might, for example, be as high as 21 inches or more and as low as 12 inches or less).

At least one light (such as a bar light, which light might have various sizes) is mounted approximately, but not limited to, 7 inches above the surface of the floor (again, the exact positioning may vary and may depend on various criteria such as cart size, color and other cosmetic features).

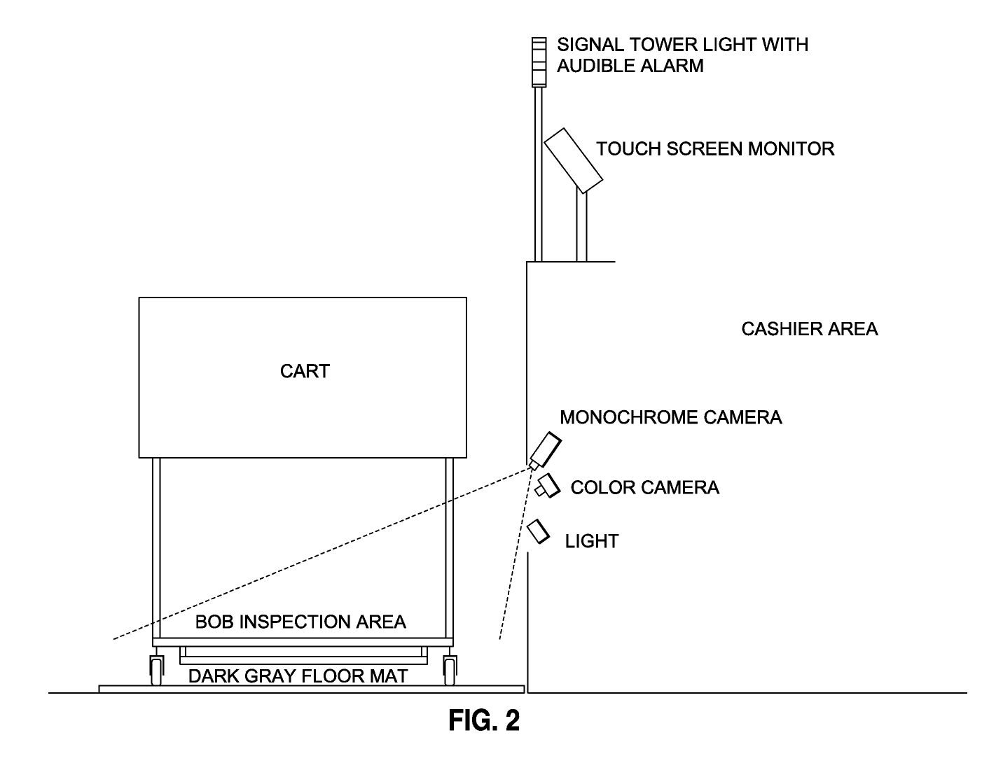

Both the at least one camera and at least one light are preferably mounted to, in, or near the cashier's cabinet panel in a cart lane aisle (see FIG. 2) or other target location/zone. The location or position of the system elements could change, such as based on the direction of flow of the carts and the configuration of the cashier station or cabinet. Preferably, these elements are consistently mounted in a manner that will allow carts to pass by the inspection zone, which zone could be on either side of the aisle/cashier cabinet. These elements could be mounted in a standalone enclosure that could be mounted adjacent to the carts' travel direction. When the elements are mounted in an enclosure or where the cashier cabinet or one separate thereto, panel cutouts may allow the camera and lights to be exposed to the cart aisle/lane. The lights could be incorporated into rubber bumpers, moldings, protrusions, added mounting devices, towers, etc. that are mounted to the cabinet in a manner to guide the cart and prevent damage from the cart.

In one embodiment, the system includes one camera having a wide angle lens and a light filter (matched to the wave length of the light). In other embodiment, the camera might include other filters or the like, such as depending upon the ambient lighting conditions.

Preferably, each camera is connected to a controller, such as a computing device, so that an output of the camera may be provided to the controller. Such a connection might be via an Ethernet cable connection or by other wired or wireless connections (including direct links or network links).

In one embodiment, the one or more lights may also be connected to the controller, such as to allow the controller to turn the lights on and off (such as to turn them off during non-use, etc). In other embodiments, the one or more lights might be separately controlled.

The system may include one or more additional cameras, such as for various surveillance reasons including, but not limited to, allowing different and additional images to be displayed, such as by the cashier monitor described below. Such cameras may be of various types and might be used, for example, to provide a video output for display.

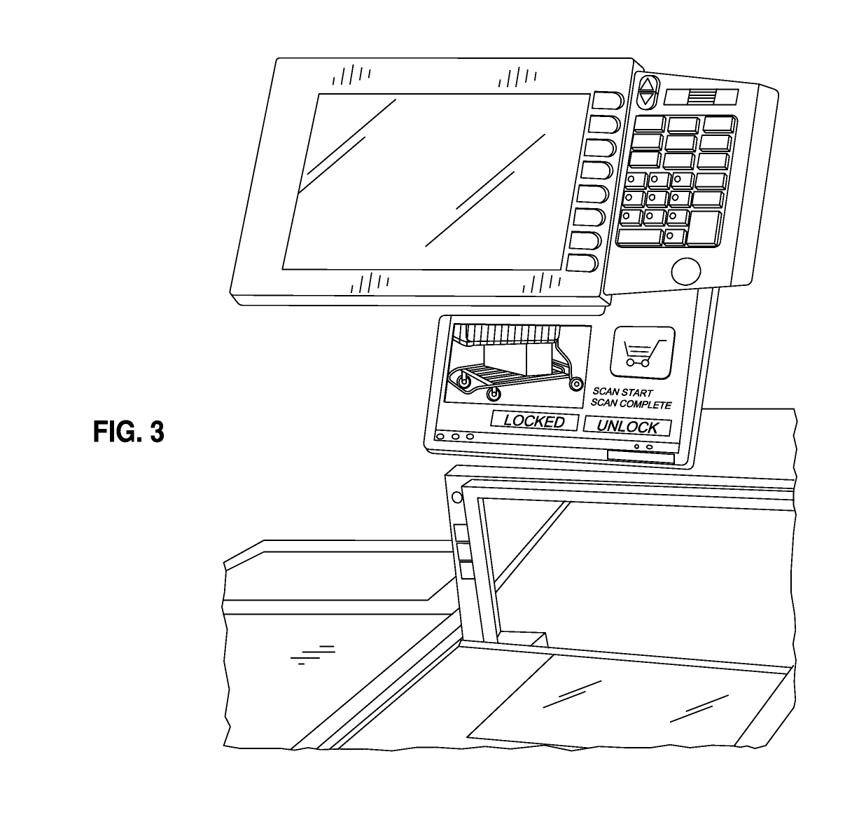

In one embodiment, the system includes a cashier monitor or display. The cashier monitor might comprise, for example, a small VGA touch screen monitor which is mounted in cashier area, such as illustrated in FIG. 3, for ease of viewing by the cashier. This video display may be used to also provide the cashier with notifications of target items in the BOB area. In a preferred embodiment, cashier monitor is controlled by the controller, such as to permit the controller to output specific information thereto.

The controller might comprise, for example, a small computing device which has a processor, a memory and one or more input and output devices or ports. The memory may be used to store data and/or computer readable program code. The processor may be configured to execute the computer readable program code. The input and output devices may be configured to receive inputs, such as video information, from the external devices and output or send information, such as control instructions. As described below, the system preferably includes means for comparing or detecting items. Such means may comprise software which is executed by the controller (though the controller could be hardware which is configured to perform various of the steps or functions described herein).

As illustrated in FIG. 1, the detection and display elements corresponding to a single location or lane might be controlled by or be associated with a single controller. In such a configuration, multiple systems (each having its own controller) might be installed at a single location, such as corresponding to each check-out lane. In such a configuration, each of the individual systems might be linked to a one or more central controllers or computers. Such a central computer might be located in a back office or the like and be used to control each individual system. In another embodiment, a single controller might control the elements corresponding to more than one location or lane. For example, a single or main controller or computer might control the camera, lights and displays associated with multiple cashier stations or lanes.

The system might include other elements or features. For example, a signal light and/or audible alarm/speaker may be located in the cashier area such as to be clearly visible to and/or heard by the cashier and/or shopper. The signal light and/or audible alarm might be triggered by the controller in the event an item is detected in the BOB. The audible alarm might, for example, comprise an MP3 format data file which is played by the controller and which generates an output to a speaker.

A mat, such as a dark gray floor mat, may be located in the camera zone, preferably on the floor. The mat may have a size of 33 inches wide by 44 inches long, though the actual size could be larger or smaller depending on cart or lane dimensions. The configuration of the mat, such as its color, is preferably used to help ensure good image contrast between a cart located in the zone and the floor or other surrounding elements.

Method of Operation

The bar light provides illumination to the camera inspection region. The camera with a lens filter captures images (such as represented by digital data) and transfers them to the controller. A light filter matched to the wavelength of the light ensures that the effects of ambient light are kept to a minimum so as not to affect the vision inspection software. The image information from the camera with lens filter or from a separate camera is also preferably transferred from the controller to the cashier monitor to provide real time (or near real time) to the cashier. Preferably, the controller executes image inspection software upon the provided image information in order to identify BOB items.

As a cart enters the camera viewing areas, the controller (such as by specifically designed recognition software) analyze the image information (which is preferably in the form of streaming video information). In one configuration, the controller first attempts to identify the bottom horizontal side frame of the cart or other definable features that could be used to identify the cart (such could include added fixtures that are either designed into the cart or added to an existing cart, such as bar codes, fiducials or other specific features that could be recognized by the inspection system thus differentiating the cart from other things in the zone, such as shopper's feet, legs, wheel chairs, walkers, crutches and other walking support devices).

Once the bottom horizontal side frame of the cart has been identified and located by the controller, the controller next looks for the vertical frame bar of the cart. The combination of these two features ensures that the cart is in the correct position for the next step of inspecting for BOB items.

Immediately after the controller confirms the two locating features, inspection tools are applied to the BOB inspection area. In one embodiment, BOB items directly reflect the light back into the camera and appear as bright white objects to the vision inspection software. Any bright objects that appear in the BOB inspection region, and meets the minimum size threshold, cause the controller to output discrete signals to the signal light and/or audible alarm to alert cashier to the presence of items in the BOB.

At the same time that the inspection software identifies the BOB items, real time image feeds are stopped to the monitor so that the image is “frozen” on the image with the BOB items. The cashier can use this image as a quick visual reference to confirm the presence of the BOB item(s). A reset button may be displayed upon the cashier's monitor which, when pressed, turns off the light and alarm and sends the image with a time stamp to the controller or a central controller, and then puts monitor back into real time image mode. The controller or central controller may run image acquisition management software. The time stamped images can then be compared to cash register records to ensure that all BOB items have been checked into the point of sale (“POS”) system.

### Other Embodiments

Of course, the present invention may have configurations other than those described above. For example, in one embodiment a system may comprise at least one isle system and one or more main or administrative system elements. Each lane or isle system may comprise at least two cameras. One camera may be used as a foreground camera (to capture images of objects in a first location, such as close to the camera) and another camera may be used as a background camera (to capture images of objects in a second location, such as far from the camera). The outputs of each pair of cameras may be provided to a local image processor, such as a lane or isle computing device (such as a local controller having a processor which is configured to execute machine readable code). The local controller or image processor preferably utilizes the outputs from the pair of cameras to generate image data, such as photographic three-dimensional image data or a graphical rendering of a shopping cart and objects associated therewith. Preferably, the computing device eliminates or removes image information which is located adjacent to the shopping cart but which is not associated with the shopping cart (such as a cashier in another isle, a customer, a point of sale display rack, etc.).

The local computing device is preferably configured to cause image information to be displayed on at an associate cashier monitor, such as described above. Such image information may include the image of the shopping cart and/or associated objects, such as images of BOB items (but preferably not other objects, such as foreground/background objects which do not comprise the shopping cart or objects associated with the cart).

In one embodiment, each lane or isle system is connected to an administrative system (such that multiple lane or isle systems may be associated with a single administrative system). The administrative system may comprise at least one server or data mass storage device. Each lane or isle computing device may be configured to transmit collected and/or rendered image data, such as in compressed or encoded form, to the server. The server may be configured to store the collected image information, such as for later playback, auditing or the like. In one embodiment, a switch may be located between multiple lane or isle systems and the server, whereby packetized information may be transmitted from the multiple lane or isle systems to the server.

In one embodiment, the administrative portion of the system may also include an administrative computer. The administrative computer may communicate with the lane or isle systems and/or the server, such as via one or more wired and/or wireless communication links. The administrative computer may include a controller or processor which is configured to execute machine readable code, such as to cause the administrative computer to access and display collected image information from each lane or isle system and/or to control each lane or isle system.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A bottom of the shopping cart inspection system for a cashier station comprising:
at least one isle system comprising:
a main controller;
at least one light configured to illuminate a target zone adjacent said cashier station at which a shopping cart may be located;
at least one first camera having a light filter configured to obtain image information from the target zone and output image information to said main controller;
at least one audible or visible alarm element coupled to said main controller; and
at least one video display at said cashier station;
wherein said main controller is configured to detect a shopping cart in said target zone and, once detected, utilize said image information to detect items in the bottom of said shopping cart and, if an item is detected, trigger said at least one audible or visible alarm and cause said at least one video display to display an image of said item.

2. The system in accordance with claim 1 wherein said isle system further comprises at least a second camera, wherein said first camera is utilized to capture foreground image information and said second camera is utilized to capture background image information.

3. The system in accordance with claim 1 comprising at least two isle systems, each isle system communicatively coupled to at least one administrative system.

4. The system in accordance with claim 1 wherein said administrative system comprises at least one data storage device configured to store image information collected by said at least one camera of each isle system and at least one administrative computing device.

5. The system in accordance with claim 4 wherein each main controller is configured to compress or encode said image information for transmission to said at least one data storage device.

6. A bottom of the shopping cart inspection system for a cashier station comprising:
at least one isle system comprising:
a main controller;
at least one first camera configured to capture foreground image information from the target zone and output foreground image information to said main controller;
at least one second camera configured to capture background image information from the target zone and output background image information to said main controller; and
at least one video display at said cashier station;
wherein said main controller is configured to detect a shopping cart in said target zone and cause said at least one video display to display image information regarding said shopping cart and items associated therewith.

7. The system in accordance with claim 6 wherein said main controller is configured to prevent the display of image information regarding objects around said shopping cart.

8. The system in accordance with claim 6 comprising at least two isle systems, each isle system communicatively coupled to at least one administrative system.
